(19) United States
(12) Patent Application Publication
(10) Pub. No.: US 2016/0249650 A1
(43) Pub. Date: Sep. 1, 2016

(54) METHOD FOR ABOSRBING AND DRAINING OIL FROM FRIED FOOD USING AN OIL ABSORBENT PAPER

(71) Applicant: Edric Sizemore, Richton Park, IL (US)

(72) Inventor: Edric Sizemore, Richton Park, IL (US)

(21) Appl. No.: 15/065,866

(22) Filed: Mar. 10, 2016

Related U.S. Application Data
(63) Continuation-in-part of application No. 14/834,975, now abandoned.
(60) Provisional application No. 62/042,916, filed on Aug. 28, 2014.

(51) Int. Cl. A23C 15/14

(52) U.S. Cl. CPC A23L 1/0155; A23V 2002/00

(57) ABSTRACT

The various embodiments herein relate to a method of absorbing and draining oil from fried food using an oil absorbent paper. The method comprises dispensing an oil absorbent paper from a tubular roll. The tubular roll comprises a plurality of longitudinal “V” shaped protruding grooves and the oil absorbent paper is rolled over the tubular roll. The fried food is placed over the dispensed oil absorbent paper. The dispensed oil absorbent paper drains off an excess oil from the fried food through a plurality of longitudinal protruding grooves. The plurality of longitudinal protruding grooves are made out of the oil absorbent paper.

### CROSS REFERENCE TO THE RELATED APPLICATION

This application claims the priority of U.S. provisional patent application No. 62/042,916 filed on Aug. 28, 2014 with title “Oil Absorbing Method for Fried Foods” and content of which is incorporated herein by reference in its entirety.

### BACKGROUND

1. Technical Field of Invention

The embodiments herein generally relate to oil absorbing method from fried foods and particularly to an oil absorbing method for fried food using an oil absorbent paper. The embodiments herein more particularly relate to a simple oil absorbing method for draining grease from fried food using a pleated oil absorbent paper.

2. Description of Related Art

For many years, tens of millions of people in this country have enjoyed eating fried foods. Fried foods are prevalent in restaurants and on dinner tables everywhere. Fried foods are the choicest food for a majority of population. Unfortunately, fried foods, such as French fries, fried chicken and donuts are not healthy choices because they soak up a lot of oil and posses lots of extra calories leading to problems like high cholesterol level and high blood pressure. Fried foods also lead to weight gain, bad health and wreak havoc on the blood sugar levels. Although millions of Americans understand that over eating fried food, cooked and soaked in grease is not good for health, but still they continue to eat fried foods by attempting to remove excessive oil from the food by utilizing various methods in order to reduce the amount of fat and calories consumed.

Some of these methods are homemade attempts to mitigate the problem of consuming too much oil when eating fried foods. One method currently being utilized is, placing the fried foods on an oven rack to allow the excess oil to drip off the food and remain crispy. While this prior method provides a convenient and basic approach to drip excessive oil from the food, it also allows the oil to dry up into the food after a period of time because there is no means of pulling or absorbing the oil from the fried food. Therefore, this prior method does not provide a quick and effective solution for removing as much oil from the fried food.

Another method used for removing excessive oil from fried food is, to place the fried food on brown bag paper to allow the oil to soak into the paper. While this prior method provides an inexpensive way to absorb the oil from the fried food, it also allows the food to rest in the puddles of oil and become soggy, therefore, defeating the purpose of pulling the oil away from the food because the oil remains in contact with the food. This prior method does not provide a quick and effective solution for removing as much oil from the fried food as possible.

Another homemade method used for removing excessive oil from fried food is, to place the fried food on a white towel to allow the oil to soak into the towel. While this prior method provides an inexpensive way to absorb the oil from the fried food and into the towel, it also creates a messy and time consuming situation when cleaning the oil off the towel. Furthermore, fabric from the towel is likely to adhere and attract to the hot fried food while the food is cooling. This prior method does not provide a quick and effective solution for removing as much oil from the fried food as possible.

There is no prior art that provides solutions for effectively removing excessive cooking oil from fried foods, hence there is a need to develop a simple and effective system or a method of removing excessive oil easily from the fried food without damaging the food. There is a need to provide a convenient method and tool to effectively absorb and drain oily grease from fried foods in order to reduce the amount of fat and calories consumed.

The above mentioned shortcomings, disadvantages and problems are addressed herein, as detailed below.

### SUMMARY OF THE INVENTION

Thus, the primary object of the embodiments herein is to provide an oil absorbing method for draining oily grease from fried foods with an oil absorbent pleated paper that is rolled-up around a uniquely shaped tube or a circular tube and dispensed from a box or container.

Another object of the embodiments herein is to provide a uniquely shaped, sturdy, tubular roll comprising an outer surface with several protruding “V” shaped pleated grooves to accommodate, with alignment, the absorbent pleated paper, which is rolled around the tube in layers for storing and dispensing several yards.

Yet another object of the embodiments herein is to provide a pleated absorbent paper that may be constructed of medium or heavy stock paper, from various absorbing materials, to retain the “V” shaped pleated grooves incorporated throughout the entire surface of the paper.

Yet another object of the embodiments herein is to provide a pleated absorbent paper with “V” shaped pleated grooves that may comprise multiple layers of absorbing paper or multiple layers in the bottom reservoirs.

Yet another object of the embodiments herein is to provide an absorbent paper with pleats incorporated throughout the entire surface that vary in length and size to elevate the fried food in order to drain off the oily grease into the reservoir grooves.

Yet another object of the embodiments herein is to provide a tubular pleated roll, which is housed in a box or container and may be connected to left and right side circular male connectors to elevate the tubular pleated roll to enable it to easily rotate and turn around each male circular connector in the box or container to dispense several yards when pulled out of the box or container.

Yet another object of the embodiments herein is to provide a tubular pleated roll, which is housed in a box or container incorporated with a horizontal cutting tool that extends the length of the box or container, which is used to cut the absorbing paper at various lengths.

Yet another object of the embodiments herein is to provide pleated absorbent paper that may be dispensed in sheets of various sizes from a horizontal, “flat-like” box, comprising an inner bottom surface with protruding “V” shaped pleated grooves incorporated throughout the entire bottom surface to accommodate, with alignment, several layers of pleated absorbent sheets.

Yet another object of the embodiments herein is to provide a convenient tool and method that enables the user to drain oily grease from fried foods to reduce the amount of oil, fat and calories normally consumed from fried foods.

According to an embodiment herein, a method for absorbing and draining oil from fried food using an oil absorbent paper is provided. The method comprises dispensing an oil absorbent paper from a dispensing device. The dispensing device is in the form of a tubular roll having a plurality of longitudinal “V” shaped protruding grooves. The oil absorbent paper is rolled over the tubular roll. The fried food is placed over the dispensed oil absorbent paper.

The dispensed oil absorbent paper drains off an excess oil from the fried food through a plurality of longitudinal protruding grooves. The plurality of longitudinal protruding grooves are made out of the oil absorbent paper.

The oil absorbent paper is made up of a medium or a heavy stock material to place the fried food without any bending of the paper.

The tubular roll rotates around two male circular connectors placed on a left side and a right side of a box to dispense the oil absorbent paper freely.

The tubular roll maintains a pleated shape of the absorbent paper.

The dispensing device is a rectangular box having an inner bottom surface lined with a plurality of longitudinal “V” shaped protruding grooves. The oil absorbent paper is dispensed in the form of pleated sheets already accommodated inside the box.

The dispensing device is a circular tubular roll.

The tubular roll is placed inside a box.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 shows a flow chart showing the various steps involved in the method for draining grease from fried food using an oil absorbent paper, according to an embodiment herein.

FIG. 2 is a perspective view of the tubular roll with “V” shaped groves placed inside a box or container, according to an embodiment herein.

FIG. 3 shows a perspective view of the tubular roll, according to an embodiment herein.

FIG. 4 shows the pleated absorbent paper, according to an embodiment herein.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method for absorbing and draining oil from fried food using an oil absorbent paper. The method comprises dispensing an oil absorbent paper from a dispensing device. The fried food is then placed over the dispensed oil absorbent paper.

According to one embodiment herein, the dispensing device is in the form of a tubular roll having a plurality of longitudinal “V” shaped protruding grooves. The oil absorbent paper is rolled over the tubular roll. The dispensed oil absorbent paper drains off an excess oil from the fried food through a plurality of longitudinal protruding grooves. The plurality of longitudinal protruding grooves are made out of the oil absorbent paper. The oil absorbent paper is made up of a medium or a heavy stock material to place the fried food without any bending of the paper. The tubular roll rotates around two male circular connectors placed on a left side and a right side of a box to dispense the oil absorbent paper freely. The tubular roll maintains a pleated shape of the absorbent paper.

According to another embodiment herein, the dispensing device is a rectangular box having an inner bottom surface lined with a plurality of longitudinal “V” shaped protruding grooves. The oil absorbent paper is dispensed in the form of pleated sheets already accommodated inside the box.

According to another embodiment herein, the dispensing device is a circular tubular roll.

According to another embodiment herein, the tubular roll is placed inside a box.

The embodiments herein provide an oil absorbing method for draining grease from fried foods with oil absorbent pleated paper that is dispensed from a uniquely shaped tubular roll, a circular tubular roll or a horizontal flat-like box. The oil absorbent pleated paper is rolled-up around a uniquely shaped tube and dispensed from a box or a container. A uniquely shaped, sturdy, tubular roll comprises an outer surface with several protruding “V” shaped pleated grooves to accommodate, with alignment, the absorbent pleated paper, which is rolled around the tube in layers for storing and dispensing several yards. A pleated absorbent paper is made up of medium or heavy stock paper from various absorbing materials to retain the “V” shaped pleated grooves incorporated throughout the entire surface of the paper. The pleated absorbent paper with “V” shaped pleated grooves comprises multiple layers of absorbing paper or multiple layers in the bottom reservoirs. An absorbent paper with pleats incorporated throughout the entire surface varies in length and size to elevate the fried food in order to drain off the oily grease into the reservoir grooves.

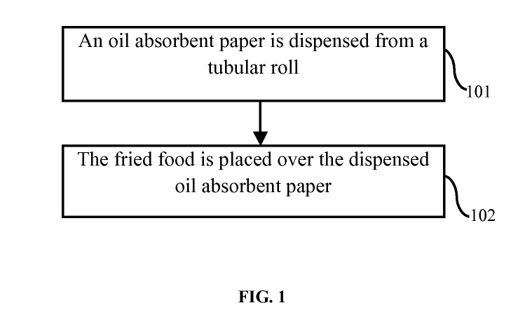

FIG. 1 shows a flow chart showing the various steps involved in the method for draining grease from fried food using an oil absorbent paper, according to an embodiment herein. With respect to FIG. 1, an oil absorbent paper is dispensed from a tubular roll (101). The tubular roll comprises a plurality of longitudinal “V” shaped protruding grooves. The oil absorbent paper is rolled over the tubular roll. The fried food is placed over the dispensed oil absorbent paper (102). The dispensed oil absorbent paper drains off an excess oil from the fried food through a plurality of longitudinal protruding grooves after placing the fried food. The plurality of longitudinal protruding grooves are made out of the oil absorbent paper. The oil absorbent paper is made up of a medium or a heavy stock material to place the fried food without any bending of the paper. The tubular roll rotates around two male circular connectors placed on a left side and a right side to dispense the oil absorbent paper freely. The oil absorbent paper is dispensed in the form of pleated sheets. The tubular roll maintains a pleated shape to the absorbent oil.

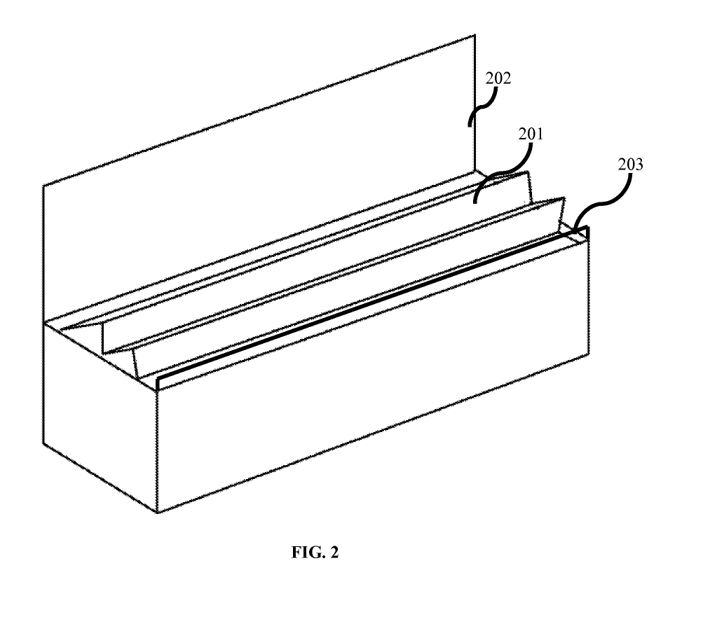

FIG. 2 is a perspective view of the tubular roll with “V” shaped groves placed inside a box or container, according to an embodiment herein. With respect to FIG. 2, the tubular pleated roll 201 is housed in a box or container 202. The box or container is incorporated with a horizontal cutting tool 203 extending along the length of the box or container. The cutting tool is used to cut the absorbing paper at various lengths.

According to another embodiment herein, the tubular pleated roll is connected to left and right side circular male connectors to elevate the tubular pleated roll to enable it to easily rotate and turn around each male circular connector in the box or container to dispense several yards when pulled out of the box or container.

According to another embodiment herein, the pleated absorbent paper is dispensed in sheets of various sizes from a horizontal, “flat-like” box, comprising an inner bottom surface with protruding “V” shaped pleated grooves incorporated throughout the entire bottom surface to accommodate, with alignment, several layers of pleated absorbent sheets.

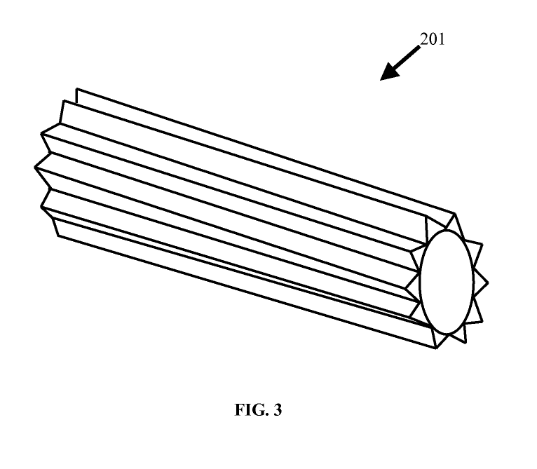

According to one embodiment herein, the present invention provides an oil absorbing method for draining excessive oily grease from fried foods by utilizing oil absorbent pleated paper that is dispensed from a tubular roll. FIG. 3 shows a perspective view of the tubular roll, according to an embodiment herein. With respect to FIG. 3, the tubular roll 201 comprises an outer surface with several protruding “V” shaped pleated grooves to accommodate and dispense the pleated absorbent paper. The “V” shaped pleated grooves elevate the fried food while cooling down and absorb and drain the excessive oil into the reservoir grooves, away from the food, for quick disposal.

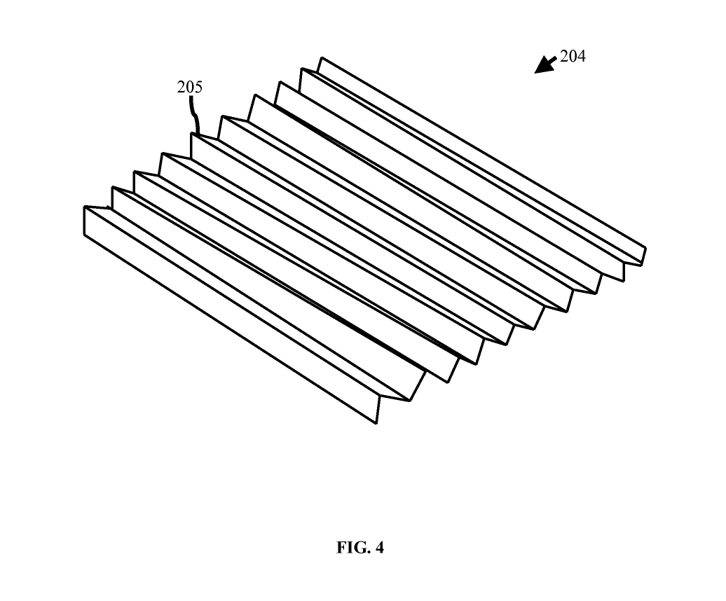

FIG. 4 shows the pleated absorbent paper, according to an embodiment herein. With respect to FIG. 4, the pleated absorbent paper 204 comprises “V” shaped pleated grooves 205. The “V” shaped pleated grooves elevate the fried food while cooling down and absorb and drain the excessive oil into the reservoir grooves, away from the food, for quick disposal.

The present invention provides a convenient roll of oil absorbent pleated paper that helps in raising the fried food to a height in order to absorb and drain the excessive oil into the reservoir grooves, away from the food for quick disposal, while the food is resting and cooling down. The area for absorption and its distribution is higher due to zig-zag arrangement of the absorbent paper. Due to the presence of “V” shaped pleated grooves the time for oil saturation in absorbent material increases which allows more absorption of oil.

According to an embodiment herein, an oil absorbing method for fried foods is provided to drain oily grease from fried foods using an oil absorbent pleated paper. The oil absorbent pleated paper is dispensed from a tubular roll. The tubular roll comprises an outer surface with several protruding “V” shaped pleated grooves to accommodate with alignment, pleated absorbent paper rolled around the tube for storage and dispensing. The tubular pleated roll is housed in a box or container and may be connected to left and right side circular male connectors to enable the tubular pleated roll to easily rotate and turn in the box or container to dispense several yards of the pleated absorbent paper when pulled out of the box or container. The pleated absorbent paper may be constructed of medium or heavy stock paper to retain the “V” shaped pleats incorporated throughout the entire surface of the paper. The “V” shaped pleats in the absorbent paper are designed to elevate the fried food in order to drain the access oily grease away from the food and into the grooves, which are reservoirs formed by the “V” shaped pleats.

The pleated absorbent paper is constructed of a medium or heavy stock and comprises “V” shaped pleats throughout the entire surface, designed to elevate the fried food in order to drain off the oily grease into the reservoir grooves and prevent the food from resting flat on the oily paper and becoming soggy. The present invention provides a convenient tool and method that enables people to cook fried foods and subsequently drain off unwanted grease in order to enjoy fried foods with less fat, less calories and less mess in the kitchen. The oil absorbent paper is made up of a material which does not bend upon placing a food item.

A convenient tool and method that enables the user to drain oily grease from fried foods to reduce the amount of oil, fat and calories normally consumed from fried foods.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. An method for absorbing and draining oil from fried food using an oil absorbent paper, comprises:
dispensing an oil absorbent paper from a dispensing device, wherein the dispensing device is in the form of a tubular roll having a plurality of longitudinal “V” shaped protruding grooves, and wherein the oil absorbent paper is rolled over the tubular roll; and
placing a fried food over the dispensed oil absorbent paper.

2. The method according to claim 1, wherein the dispensed oil absorbent paper drains off an excess oil from the fried food through a plurality of longitudinal protruding grooves, wherein the plurality of longitudinal protruding grooves are made out of the oil absorbent paper.

3. The method according to claim 1, wherein the oil absorbent paper is made up of a medium or a heavy stock material to place the fried food without any bending of the paper.

4. The method according to claim 1, wherein the tubular roll rotates around two male circular connectors placed on a left side and a right side of a box to dispense the oil absorbent paper freely.

5. The method according to claim 1, wherein the tubular roll maintains a pleated shape of the absorbent paper.

6. The method according to claim 1, wherein the dispensing device is a rectangular box having an inner bottom surface lined with a plurality of longitudinal “V” shaped protruding grooves, wherein the oil absorbent paper is dispensed in the form of pleated sheets already accommodated inside the box.

7. The method according to claim 1, wherein the dispensing device is a circular tubular roll.

8. The method according to claim 1, wherein the tubular roll is placed inside a box.
